(19) United States
(12) Patent Application Publication
(10) Pub. No.: US 2020/0241876 A1
(43) Pub. Date: Jul. 30, 2020

(54) Range Mapping of Input Operands for Transcendental Functions

(71) Applicant: Apple Inc., Cupertino, CA (US)

(72) Inventors: O-Cheng Chang, Cupertino, CA (US); Tal Uliel, San Francisco, CA (US); Eric Bainville, Sunnyvale, CA (US); Jeffry E. Gonion, Campbell, CA (US); Ali Sazegari, Los Altos, CA (US)

(21) Appl. No.: 16/847,068

(22) Filed: Apr. 13, 2020

Related U.S. Application Data
(62) Division of application No. 15/896,582, filed on Feb. 14, 2018.

(51) Int. Cl. G06F 9/30; G06F 9/38

(52) U.S. Cl. CPC G06F 9/30076; G06F 9/3004; G06F 9/3802

(57) ABSTRACT

In an embodiment, a processor (e.g. a CPU) may offload transcendental computation to a computation engine that may efficiently perform transcendental functions. The computation engine may implement a range instruction that may be included in a program being executed by the CPU. The CPU may dispatch the range instruction to the computation engine. The range instruction may take an input operand (that is to be evaluated in a transcendental function, for example) and may reference a range table that defines a set of ranges for the transcendental function. The range instruction may identify one of the set of ranges that includes the input operand. For example, the range instruction may output an interval number identifying which interval of an overall set of valid input values contains the input operand. In an embodiment, the range instruction may take an input vector operand and output a vector of interval identifiers.

This application is a divisional of U.S. patent application Ser. No. 15/896,582, filed on Feb. 14, 2018. The above application is incorporated herein by reference in its entirety.

### BACKGROUND

### Technical Field

Embodiments described herein are related to computation engines that assist processors and, more particularly, to computation engines that evaluate transcendental functions.

### Description of the Related Art

A variety of workloads being performed in modern computing systems rely on significant use of transcendental functions. For example, certain long short term memory (LSTM) learning algorithms are used in a variety of contexts such as language detection, card readers, natural language processing, handwriting processing, and machine learning, among other things. LSTM processing includes numerous evaluations of select transcendental functions in the front end (initialization) portion of the processing, up to about 15% of the instructions executed.

A transcendental function is an analytic function that does not satisfy a polynomial equation. That is, a transcendental function cannot be expressed in terms of a finite sequence of the algebraic operations of addition, multiplication, and root extraction. Examples of transcendental functions include the exponential function, the logarithm, and the trigonometric functions (e.g. sine, cosine, etc.). Thus, accurate computation of transcendental functions over the entire valid input range is complex and time consuming. However, if the entire input range is divided into intervals, the transcendentals can be approximated with high accuracy using relatively low-order polynomials. Different polynomials are used in different intervals. Thus, a high performance mechanism to select the polynomial for an input to the transcendental function and to evaluate the transcendental function can improve the performance of workloads that use significant amounts of transcendental function evaluation. The performance of such operations on a general purpose central processing unit (CPU) is often very low; while the power consumption is very high. Low performance, high power workloads are problematic for any computing system, but are especially problematic for battery-powered systems.

### SUMMARY

In an embodiment, a processor (e.g. a CPU) may offload work to a computation engine that may efficiently perform transcendental functions. The computation engine may implement a range instruction that may be included in a program being executed by the CPU. The CPU may dispatch the range instruction to the computation engine. The range instruction may take an input operand (that is to be evaluated in a transcendental function, for example) and may reference a range table that defines a set of ranges for the transcendental function. The range instruction may identify one of the set of ranges that includes the input operand. For example, the range instruction may output an interval number identifying which interval of an overall set of valid input values contains the input operand. In an embodiment, the range instruction may take an input vector operand and output a vector of interval identifiers.

In an embodiment, the interval identifier(s) produced by the range instruction may be provided as index(es) into a lookup table. The lookup table may include, e.g. the coefficients for polynomials corresponding to each interval of a transcendental function, thereby selecting the polynomial for evaluation in the computation engine. While the range instruction may be used for transcendental function evaluation in one use case, such use is merely exemplary and numerous other uses of the range instruction are possible.

In an embodiment, determining intervals for input operands using the range instruction may contribute to a high performance, low power solution to various workloads executed by the CPU in a system. For example, the range instruction may be part of performing transcendental operations in certain workloads. LSTM workloads for machine learning tasks may benefit in the initialization section of the LSTM processing, in one particular use case. The initialization section may be up to 15% of the instructions executed to implement LSTM, as mentioned previously. For energy constrained systems (e.g. battery-operated mobile systems) and/or thermally-constrained systems (e.g. rack servers), improved performance and/or enhanced capabilities in the machine learning area may result.

### BRIEF DESCRIPTION OF THE DRAWINGS

The following detailed description makes reference to the accompanying drawings, which are now briefly described.

FIG. 1 is a block diagram of one embodiment of a processor, a computation engine, and a lower level cache.

FIG. 2 is a block diagram illustrating a range table used by one embodiment of a range instruction.

FIG. 3 is a block diagram of an input vector to one embodiment of a range instruction and an output vector from the range instruction.

FIG. 4 is a block diagram of an exemplary transcendental curve and intervals defined thereon.

FIG. 5 is a block diagram illustrating vector remapping for one embodiment using a range table as part of the operation.

FIG. 6 is a flowchart illustrating operation of one embodiment a computation engine for a range instruction.

FIG. 7 is table of instructions which may be used for one embodiment of the processor and computation engine.

FIG. 8 is a table illustrating exemplary input operand data types and sizes, and output interval value sizes for those input operand data types.

FIG. 9 is a block diagram of one embodiment of a system.

FIG. 10 is a block diagram of one embodiment of a computer accessible storage medium.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to. As used herein, the terms “first,” “second,” etc. are used as labels for nouns that they precede, and do not imply any type of ordering (e.g., spatial, temporal, logical, etc.) unless specifically stated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “clock circuit configured to generate an output clock signal” is intended to cover, for example, a circuit that performs this function during operation, even if the circuit in question is not currently being used (e.g., power is not connected to it). Thus, an entity described or recited as “configured to” perform some task refers to something physical, such as a device, circuit, memory storing program instructions executable to implement the task, etc. This phrase is not used herein to refer to something intangible. In general, the circuitry that forms the structure corresponding to “configured to” may include hardware circuits. The hardware circuits may include any combination of combinatorial logic circuitry, clocked storage devices such as flops, registers, latches, etc., finite state machines, memory such as static random access memory or embedded dynamic random access memory, custom designed circuitry, analog circuitry, programmable logic arrays, etc. Similarly, various units/circuits/components may be described as performing a task or tasks, for convenience in the description. Such descriptions should be interpreted as including the phrase “configured to.”

The term “configured to” is not intended to mean “configurable to.” An unprogrammed FPGA, for example, would not be considered to be “configured to” perform some specific function, although it may be “configurable to” perform that function. After appropriate programming, the FPGA may then be configured to perform that function.

Reciting in the appended claims a unit/circuit/component or other structure that is configured to perform one or more tasks is expressly intended not to invoke 35 U.S.C. § 112(f) interpretation for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

In an embodiment, hardware circuits in accordance with this disclosure may be implemented by coding the description of the circuit in a hardware description language (HDL) such as Verilog or VHDL. The HDL description may be synthesized against a library of cells designed for a given integrated circuit fabrication technology, and may be modified for timing, power, and other reasons to result in a final design database that may be transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and may further include other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA.

As used herein, the term “based on” or “dependent on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

### DETAILED DESCRIPTION OF EMBODIMENTS

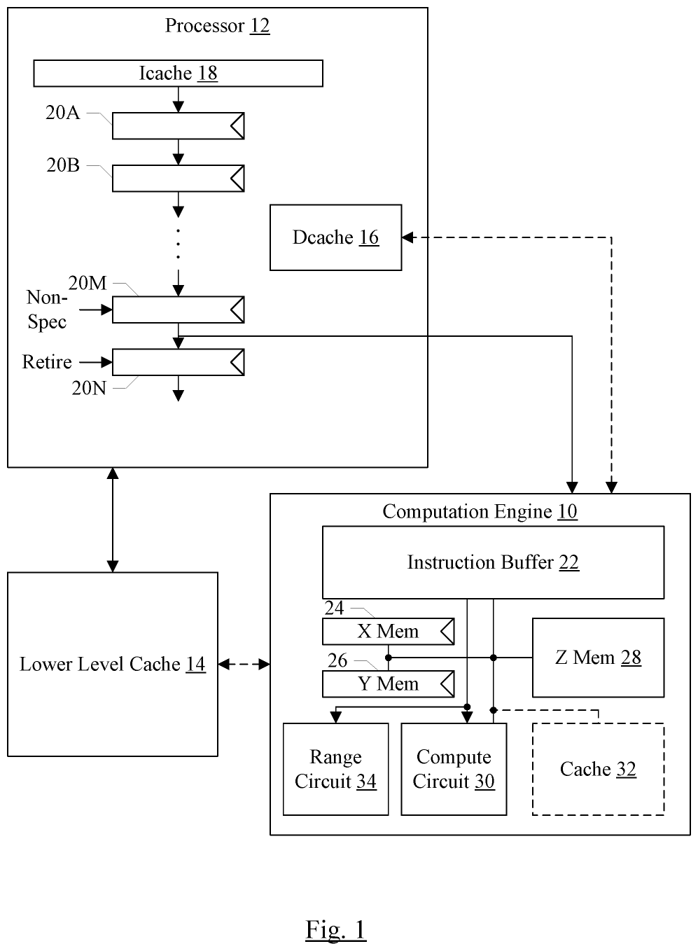

Turning now to FIG. 1, a block diagram of one embodiment of an apparatus including a processor 12, a computation engine 10, and a lower level cache 14 is shown. In the illustrated embodiment, the processor 12 is coupled to the lower level cache 14 and the computation engine 10. In some embodiments, the computation engine 10 may be coupled to the lower level cache 14 as well, and/or may be coupled to a data cache (DCache) 16 in the processor 12. The processor 12 may further include an instruction cache (ICache) 18 and one or more pipeline stages 20A-20N. The pipeline stages 20A-20N may be coupled in series. The computation engine 10 may include an instruction buffer 22, an X memory 24, a Y memory 26, a Z memory 28, a compute circuit 30, and a range circuit 34 coupled to each other. In some embodiments, the computation engine 10 may include a cache 32.

The computation engine 10 may be configured to perform one or more transcendental operations. Specifically, in an embodiment, the computation engine 10 may perform the low order polynomial evaluations corresponding to the transcendental operation, based on the interval that includes each input value to be evaluated. In an embodiment, the compute circuit 30 may perform the polynomial evaluations. The interval for each input value may be determined by executing a range instruction prior to an instruction to evaluate the polynomial. The range instruction may be performed by the range circuit 34. While the range circuit 34 and the compute circuit 30 are illustrated separately in FIG. 1, implementations may integrate the range circuit 34 and the compute circuit 30. For example, the compute circuit 30 may include an array of circuits to operate on vector elements of input vectors from the X memory 24 and/or the Y memory 26. The range circuit 34 may similarly include an array of circuits to determine the interval for vector elements of an input vector from the X memory 24 and/or the Y memory 26.

In one embodiment, the transcendental operations may be performed on vectors of input operands. For example, an embodiment receives vectors of operands (e.g. in the X memory 24 and the Y memory 26). The compute circuit 30 may include an array of circuits to perform the evaluation. Each circuit may receive vector elements from the X memory 24 or the Y memory 26, and may evaluate the polynomial corresponding to the selected vector element. Different vector elements may be included in different intervals. Accordingly, each circuit may receive the polynomial coefficients based on the interval identifier determined from a preceding range instruction.

In an embodiment, the computation engine 10 may support various data types and data sizes. For example, floating point and integer data types may be supported. The floating point data type may include 16 bit, 32 bit, and 64 bit sizes. The integer data types may include 16 bit and 32 bit sizes, and both signed and unsigned integers may be supported. Other embodiments may include a subset of the above sizes, additional sizes, or a subset of the above sizes and additional sizes (e.g. larger or smaller sizes).

In one embodiment, the large data sizes may include fewer intervals than the smaller data sizes of the same data type. That is, the number of intervals may be inversely dependent on the data size, where the maximum number of intervals decreases as the data size increases (and vice versa). In an embodiment, a range table that stores the bounds of the intervals may have a fixed size. Since the range bounds may be the same data size and data type to facilitate comparison, a range bound at a larger data size may consume more of the fixed size than a range bound at a smaller data size. Thus, more range bounds at the smaller data size may be stored in the in range table.

When the range instruction is used, e.g., to identify intervals for polynomial evaluation of transcendental functions, the input range may be limited in many cases such as LSTM initialization processing. Even though the data size can accommodate a larger range, the input for the given use case may be guaranteed to be in a subrange of the larger range. Additionally, argument reduction may be applied prior to polynomial approximation. The argument reduction may cause the reduced range to fall into ranges that may be identified via the range instruction.

Results for the polynomial evaluations may be stored in the Z memory 28. Similarly, results of the range instruction may be stored in the Z memory 28, or alternatively in one of the X memory 24 and/or Y memory 26. In an embodiment, the computation engine 10 may be configured to accumulate transcendental evaluations, and the current value in the Z memory 28 may be provided to the compute circuit 30 to be added to the result of the polynomial evaluation.

In an embodiment, the instructions executed by the computation engine 10 may also include memory instructions (e.g. load/store instructions). The load instructions may transfer vectors from a system memory (not shown) to the X memory 24, Y Memory 26, or Z memory 28. The store instructions may write the vectors from the Z memory 28 to the system memory. Other embodiments may also include store instructions to write vectors from the X and Y memories 24 and 26 to system memory. The system memory may be a memory accessed at a bottom of the cache hierarchy that includes the caches 14, 16, and 18. The system memory may be formed from a random access memory (RAM) such as various types of dynamic RAM (DRAM) or static RAM (SRAM). A memory controller may be included to interface to the system memory. In an embodiment, the computation engine 10 may be cache coherent with the processor 12. In an embodiment, the computation engine 10 may have access to the data cache 16 to read/write data. Alternatively, the computation engine 10 may have access to the lower level cache 14 instead, and the lower level cache 14 may ensure cache coherency with the data cache 16. In yet another alternative, the computation engine 10 may have access to the memory system, and a coherence point in the memory system may ensure the coherency of the accesses. In yet another alternative, the computation engine 10 may have access to the caches 14 and 16.

In some embodiments, the computation engine 10 may include a cache 32 to store data recently accessed by the computation engine 10. The choice of whether or not to include cache 32 may be based on the effective latency experienced by the outer product 10 and the desired level of performance for the computation engine 10. The cache 32 may have any capacity, cache line size, and configuration (e.g. set associative, direct mapped, etc.).

In the illustrated embodiment, the processor 12 is responsible for fetching the range instructions and computation instructions and transmitting the instructions to the computation engine 10 for execution. The overhead of the “front end” of the processor 12 fetching, decoding, etc. the instructions may be amortized over the computations performed by the computation engine 10. In one embodiment, the processor 12 may be configured to propagate the instructions down the pipeline (illustrated generally in FIG. 1 as stages 20A-20N) to the point at which the instruction becomes non-speculative. In FIG. 1, the stage 20M illustrates the non-speculative stage of the pipeline. From the non-speculative stage, the instruction may be transmitted to the computation engine 10. The processor 12 may then retire the instruction (stage 20N). Particularly, the processor 12 may retire the instruction prior to the computation engine 10 completing the computation (or even prior to starting the computation, if the computation instruction is queued behind other instructions in the instruction buffer 22).

Generally, an instruction may be non-speculative if it is known that the instruction is going to complete execution without exception/interrupt. Thus, an instruction may be non-speculative once prior instructions (in program order) have been processed to the point that the prior instructions are known to not cause exceptions/speculative flushes in the processor 12 and the instruction itself is also known not to cause an exception/speculative flush. Some instructions may be known not to cause exceptions based on the instruction set architecture implemented by the processor 12 and may also not cause speculative flushes. Once the other prior instructions have been determined to be exception-free and flush-free, such instructions are also exception-free and flush-free.

In the case of memory instructions that are to be transmitted to the computation engine 10, the processing in the processor 12 may include translating the virtual address of the memory operation to a physical address (including performing any protection checks and ensuring that the memory instruction has a valid translation).

FIG. 1 illustrates a communication path between the processor 12 (specifically the non-speculative stage 20M) and the computation engine 10. The path may be a dedicated communication path, for example if the computation engine 10 is physically located near the processor 12. The communication path may be shared with other communications, for example a packet-based communication system could be used to transmit memory requests to the system memory and instructions to the computation engine 10. The communication path could also be through system memory, for example the computation engine may have a pointer to a memory region into which the processor 12 may write computation instructions. In yet another alternative, the processor 12 may be configured to provide the program counter (PC) address from which to fetch the instruction to the computation engine 10.

The instruction buffer 22 may be provided to allow the computation engine 10 to queue instructions while other instructions are being performed. In an embodiment, the instruction buffer 22 may be a first in, first out buffer (FIFO). That is, matrix computation instructions may be processed in program order. Other embodiments may implement other types of buffers.

The X memory 24 and the Y memory 26 may each be configured to store at least one vector of input operands defined for the range instruction. Similarly, the Z memory 28 may be configured to store at least one computation result. The result may be an array of results at the result size (e.g. 16 bit elements or 32 bit elements). In some embodiments, the X memory 24 and the Y memory 26 may be configured to store multiple vectors and/or the Z memory 28 may be configured to store multiple result vectors. Each vector may be stored in a different bank in the memories, and operands for a given instruction may be identified by bank number.

The processor 12 fetches instructions from the instruction cache (ICache) 18 and processes the instructions through the various pipeline stages 20A-20N. The pipeline is generalized, and may include any level of complexity and performance enhancing features in various embodiments. For example, the processor 12 may be superscalar and one or more pipeline stages may be configured to process multiple instructions at once. The pipeline may vary in length for different types of instructions (e.g. ALU instructions may have schedule, execute, and writeback stages while memory instructions may have schedule, address generation, translation/cache access, data forwarding, and miss processing stages). Stages may include branch prediction, register renaming, prefetching, etc.

Generally, there may be a point in the processing of each instruction at which the instruction becomes non-speculative. The pipeline stage 20M may represent this stage for computation instructions, which are transmitted from the non-speculative stage to the computation engine 10. The retirement stage 20N may represent the state at which a given instruction's results are committed to architectural state and can no longer by “undone” by flushing the instruction or reissuing the instruction. The instruction itself exits the processor at the retirement stage, in terms of the presently-executing instructions (e.g. the instruction may still be stored in the instruction cache). Thus, in the illustrated embodiment, retirement of outer product instructions occurs when the instruction has been successfully transmitted to the computation engine 10.

The instruction cache 18 and data cache (DCache) 16 may each be a cache having any desired capacity, cache line size, and configuration. Similarly, the lower level cache 14 may be any capacity, cache line size, and configuration. The lower level cache 14 may be any level in the cache hierarchy (e.g. the last level cache (LLC) for the processor 12, or any intermediate cache level).

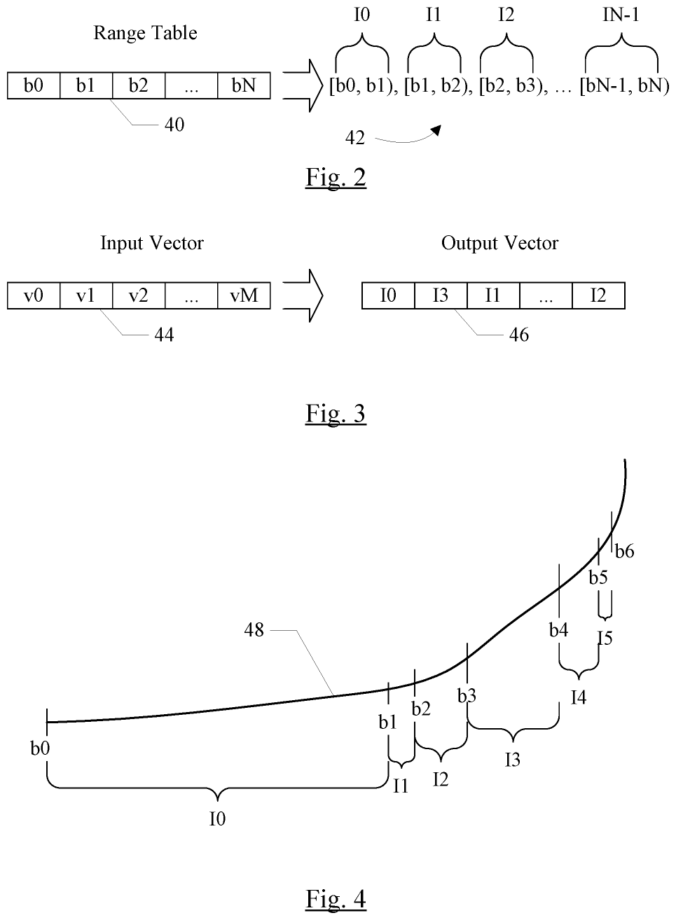

Turning now to FIG. 2, a block diagram of one embodiment of a range table 40 and the corresponding intervals defined by the contents of the range table 40 is shown. The range table 40 includes a set of range bounds (b0, b1, b2, etc. up to bN). The corresponding intervals I0 to IN−1 are illustrated at the right in FIG. 2 (reference numeral 42). Adjacent range bounds in the range table 40 define each interval in this embodiment, with one bound inclusive (bracket in FIG. 2) and one exclusive (parenthesis in FIG. 2). In FIG. 2, the lower range bound is inclusive and the upper range bound is exclusive. For the embodiment shown in FIG. 2, an input value is contained in a given interval if the input value is greater than or equal to the lower range bound of the given interval and less than the upper range bound of the given interval. Other embodiments may define the ranges such that the lower range bound is exclusive and the upper range bound is inclusive. For such an embodiment, an input value is contained in a given interval if the input value is greater than the lower range bound of the given interval and less than or equal to the upper range bound of the given interval.

When a range instruction is executed in the computation engine 10, the range circuit 34 may determine which interval I0 to IN−1 includes each vector element, and may output an identifier for the interval in the same vector position as the vector element in the output vector. FIG. 3 is an example of an input vector 44, including vector elements v0, v1, v2, etc. to vM. In the example, v0 is in interval 0 (I0), and thus the output vector includes an indication of I0 in the v0 position of the output vector 46. Similarly, v1 is in interval 3 (I3), v2 is in interval 1 (I1) and vM is in interval 2 (I2).

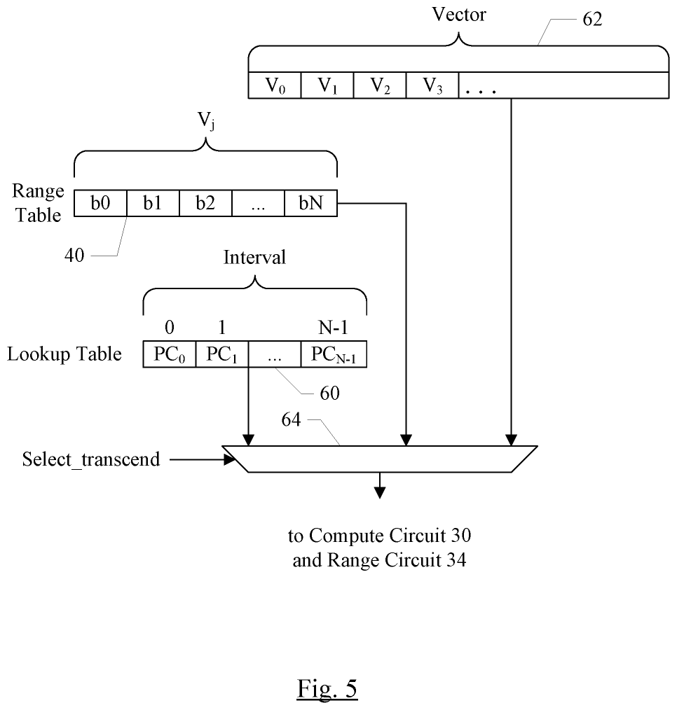

As the example in FIG. 3 illustrates, a given vector element may be in any interval, independent of the intervals of other elements of the same vector. It is noted that, while interval labels are shown in FIG. 3 for clarity in the example (I0, I1, etc.), the actual indications may merely be numbers (e.g. 0, 1, etc). Thus, the output vector 46 may be used in a variety of ways (e.g. as indexes to another table, discussed below with respect FIG. 5).

The range table 40 may be a separate table provided to the range circuit 34, or may be an entry in the X memory 24 or Y memory 26. In an embodiment, the range table 40 may be sourced from the same memory 24 or 26 as the input vector 44 for the range operation.

The range bounds may form a set of non-overlapping intervals between b0 and bN. However, depending on the values of b0 and bN and the potential input values to the transcendental function, there may be input values that are not included in any of the intervals (e.g. values less than b0 and values greater than or equal to bN). The range instruction may be defined to cause an output of a value that is not any of the intervals (e.g. a value of all binary ones). This value may be used to identify vector elements that are not evaluated via the polynomials, for example. In other embodiments, depending on the values of b0 to bN, one or more intervals may overlap.

FIG. 4 is a diagram illustrating an exemplary curve that could be part of a transcendental function. Various intervals I0 to I5 are defined on the curve, based on bounds b0 to b6. As FIG. 4 illustrates, the intervals need not be equally spaced. Instead, the intervals may be defined based on the ability of the same polynomial to accurately estimate the value on the curve for any input within the interval. For example, the polynomial may have a maximum error that is no greater than a specified tolerance within the interval. Thus, slowly changing, near linear areas of the curve may support a wide interval (e.g. I0 or I3), while more rapidly changing, less linear areas may be represented with narrower intervals (e.g. I1, I2, I4, and I5).

FIG. 5 is a block diagram illustrating an embodiment that determines intervals for vector elements and provides coefficients for a transcendental operation. In the embodiment of FIG. 5, a lookup table 60 is provided which may be programmable with values (e.g. values PC₀ to PC_{N-1} in FIG. 5). The P_{C0} to PC_{N-1} values may each be a vector of coefficients for the vector polynomial corresponding to a given interval. That is, PC₀ may be a vector of coefficients for the polynomial corresponding to interval I0; PC₁ may be a vector of coefficients for the polynomial corresponding to interval I1; etc. Thus, the index into the lookup table 60 may be the interval number for each vector element, determined in response to executing the range instruction as discussed above. The index is illustrated as “interval” above the lookup table 60, where the interval is determined from the range table 40. The interval number may be provided as the index to the lookup table 60 directly from the range table 40 (e.g. as part of the execution of the range instruction). Alternatively, the interval numbers may be written to a target operand of the range instruction, and a subsequent instruction (e.g. an arithmetic instruction provided to evaluate the transcendental function) may provide the interval numbers as indexes to the lookup table 60. The output of the lookup table 60 may be one set of operands to the compute circuit 30 and the vector elements from another source operand of the compute instruction may be the other set of operands.

Furthermore, an input vector 62 shown in FIG. 5 includes various vector elements, such as V₀ to V₃. During the execution of the range instruction, these vector elements may be compared to the ranges defined in the range table 40 (graphically illustrated as Vⱼ in FIG. 5), and the first range (from left to right in FIG. 5) that includes the vector element may determine the interval. In another embodiment, the last range (from left to right in FIG. 5) that includes the vector element may determine the interval. The range circuit 34 may be configured to perform the comparison. Thus, the range table 40 may be one set of operands for the range circuit, and the input vector 62 may be the other set of elements.

A multiplexor (mux) 64 is shown in FIG. 5 to select between the lookup table 60, the range table 40, and the input vector 62 to provide operands for the compute circuit 30 and/or the range circuit 34. When the range instruction is being executed, the range table 40 may be selected to provide the range definition to the range circuit 34, and the input vector 62 may provide the vector elements to be matched to ranges. The result intervals may be written to a target operand of the range instruction, and the target operand may be a source operand of a compute instruction that is provided as indexes to the lookup table 64. The polynomial coefficients may thus be selected for the transcendental evaluation by the compute circuit 30, and the other operand of the compute instruction may be the vector elements to be evaluated over the polynomials for the transcendental function (represented in FIG. 5 by the input vector 62). Alternatively, in another embodiment, the range instruction may be defined to identify ranges for the input vector 62 via the range table 40 and to provide the intervals to the lookup table 60 to map the intervals to polynomials. In such an embodiment the range circuit 34 may include the range table 40, or the range table 40 may be provided as operands for the range instruction along with the lookup table 60. The output of the range circuit 34 may be provided to the compute circuit 30, and the subsequent compute instruction may evaluate the input vector 62 against the corresponding polynomial values.

It is noted that different implementations of determining the range and the corresponding polynomial coefficients for a transcendental function and evaluating the function may be used. FIG. 5 illustrates the logical construction of the range table 40 and the lookup table 60, but is not necessarily physically how it is implemented.

The computation engine 10 may evaluate a variety of transcendental functions. The range table 40 and the lookup table 60 may be programmed for a given transcendental function, and then reprogrammed for a different transcendental function, as desired.

Turning now to FIG. 6, a flowchart is shown illustrating operation of one embodiment of the computation engine 10 to execute a range instruction. While the blocks are shown in a particular order for ease of illustration, other orders may be used. Blocks may be performed in parallel by combinatorial logic in the computation engine 10. Blocks, combinations of blocks, and/or the flowchart as a whole may be pipeline over multiple clock cycles. The computation engine 10, and components thereof such as the range circuit 34, may be configured to implement the operation shown in FIG. 6.

As illustrated at reference numeral 70, the operation illustrated in FIG. 6 is performed for each vector element of the input vector 62. The elements may be processed in parallel, in series, or a combination of parallel and series (e.g. two or more elements may be processed in parallel, and the parallel processing may be repeated until all elements are processed). The input vector 62 may be multiple input vectors, in an embodiment, in which case the operation illustrated in FIG. 6 is performed for each element of each vector, in parallel, series, or a combination thereof.

The computation engine 10 may find the first interval containing the element, where the intervals are defined in the range table 40 (block 72). The intervals may be viewed as ordered from left to right as shown in FIGS. 2 and 5 to define which interval is “first.” Alternatively, the intervals value viewed as ordered from right to left as shown in FIGS. 2 and 5 to define which interval is “first,” or the last interval containing the element may be identified. Since the intervals are defined by adjacent values in the range table 40, there may typically be at most one interval that contains the element. However, if the values in the range table 40 are not monotonically increasing, there may be more than one interval that contains the element. In this case, the first (or last) interval is the result of the range instruction for that element, in an embodiment. Thus, at most one interval may be identified for each vector element. If an interval is found that contains the element (decision block 74, “yes” leg), the computation engine 10 may output the interval number of the interval in the output vector, in the vector element position corresponding to the vector element in the input vector (block 76). On the other hand, if the element is not contained in any interval (decision block 74, “no” leg), the computation engine 10 may output all binary ones for the vector element (block 78). The number of binary ones may depend on the number of bits implemented for the interval numbers, which may vary depending on the size of the interval elements. Generally, the output value when an element is not contained in any interval may be any value that does not specify one of the valid ranges described by the range bounds in the range table 40. The output vector may be stored in a destination operand of the range instruction (e.g. the Z memory 28, or the X memory 24 or Y memory 26, in some embodiments).

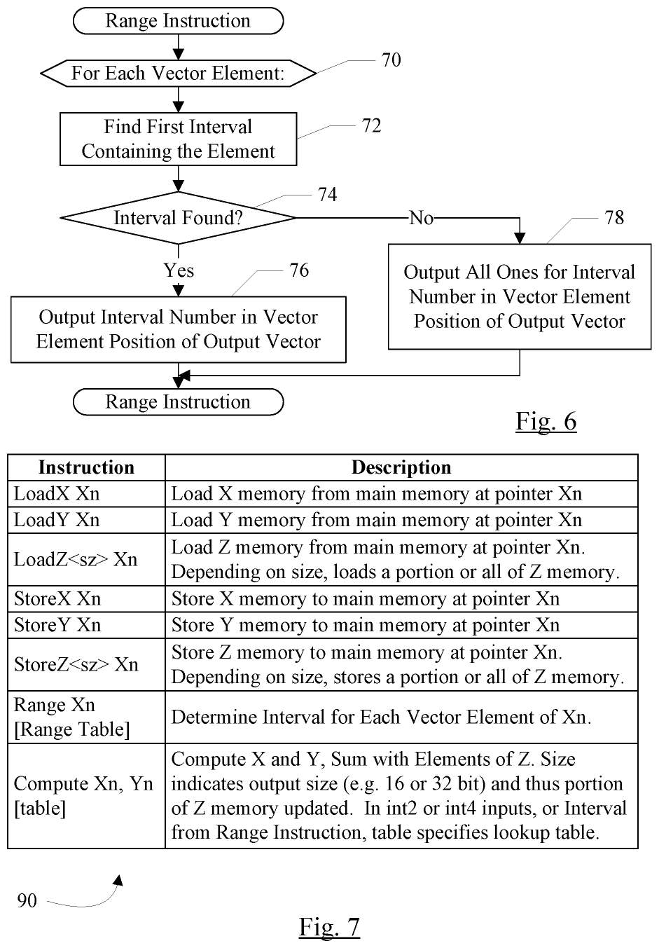

FIG. 7 is a table 90 illustrating an exemplary instruction set for one embodiment of the computation engine 10. Other embodiments may implement any set of instructions, including subsets of the illustrated set, other instructions, a combination of subsets and other instructions, etc.

The memory operations for the computation engine 10 may include load and store instructions. Specifically, in the illustrated embodiment, there are load and store instructions for the X, Y, and Z memories, respectively. In the case of the Z memory 28, a size parameter may indicate which element size is being used and thus which rows of the Z memory are written to memory or read from memory (e.g. all rows, every other row, ever fourth row, etc.). In an embodiment, the X and Y memories may have multiple banks for storing different vectors. In such an embodiment, there may be multiple instructions to read/write the different banks or there may be an operand specifying the bank affected by the load/store X/Y instructions. In each case, an X memory bank may store a pointer to memory from/to which the load/store is performed. The pointer may be virtual, and may be translated by the processor 12 as discussed above. Alternatively, the pointer may be physical and may be provided by the processor 12 post-translation.

The range instruction may determine the interval for each vector element in the vector in X memory entry Xn. A vector from a Y memory entry (e.g. Yn) may also be specified. Additionally, a source for the range table may be specified (implicitly or explicitly as an operand of the instruction). If the range table is explicitly specified, multiple range tables may be in the X memory 24 and Y memory 26 concurrently. Thus, for example, range tables for multiple different transcendental operations may be stored.

The compute instruction may perform a computation on the vector elements in the X and vectors and may sum the resulting matrix elements with the corresponding elements of the Z memory 28, in some embodiments. For example, in the case of a transcendental evaluation, the polynomial coefficients corresponding to each vector element may be multiplied by that vector element and the multiplication results may be summed to evaluate the polynomial for that vector element. Other compute instructions may be defined in various embodiments (e.g. a matrix multiply operation, etc.). The optional table operand may specify the lookup table if the input matrices use matrix elements that are smaller than the implemented size.

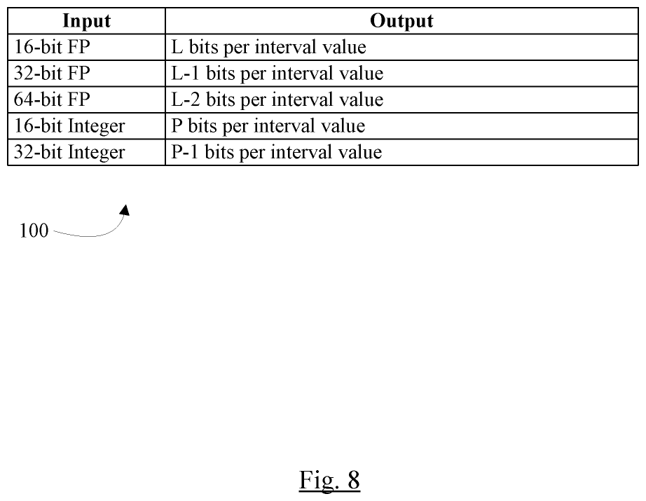

FIG. 8 is a table 100 illustrating one embodiment of various data types and data sizes, and support interval numbers for an embodiment. As previously mentioned, any set of data types and sizes may be implemented in various embodiments. As shown in table 100, the input size may be, e.g., 16 bit, 32 bit, or 64 bit floating point values and 16 bit or 32 bit integer values. Both signed an unsigned integer values may be supported, in an embodiment. The smallest floating point size (16 bits) may support up to L bits of interval value (where L is a positive integer greater than 3). The 32 bit floating point size may support one less bit of interval number (L-1) and the 64 bit floating point size may support one less bit than the 32 bits size (L-2). Similarly, the 16 bit integer value may support P bits of interval value (where P is a positive integer greater than 2) and the 32 bit integer value may support one less bit (P-1 bits). In an embodiment, since the 16 bit integer size is the same as the 16 bit floating point size, P may equal L. In other embodiments, P and L may be different (e.g. if the smallest data size is different for different data sizes).

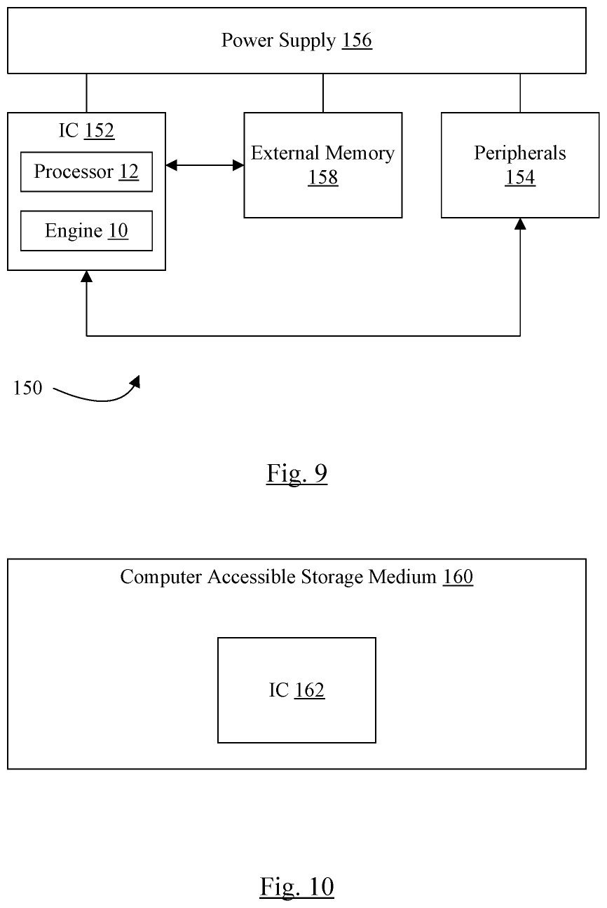

FIG. 9 is a block diagram of one embodiment of a system 150. In the illustrated embodiment, the system 150 includes at least one instance of an integrated circuit (IC) 152 coupled to one or more peripherals 154 and an external memory 158. A power supply 156 is provided which supplies the supply voltages to the IC 152 as well as one or more supply voltages to the memory 158 and/or the peripherals 154. The IC 152 may include one or more instances of the processor 12 and one or more instances of the computation engine 10. In other embodiments, multiple ICs may be provided with instances of the processor 12 and/or the computation engine 10 on them.

The peripherals 154 may include any desired circuitry, depending on the type of system 150. For example, in one embodiment, the system 150 may be a computing device (e.g., personal computer, laptop computer, etc.), a mobile device (e.g., personal digital assistant (PDA), smart phone, tablet, etc.), or an application specific computing device capable of benefiting from the computation engine 10 (e.g., neural networks, LSTM networks, other machine learning engines including devices that implement machine learning, etc.), In various embodiments of the system 150, the peripherals 154 may include devices for various types of wireless communication, such as wifi, Bluetooth, cellular, global positioning system, etc. The peripherals 154 may also include additional storage, including RAM storage, solid state storage, or disk storage. The peripherals 154 may include user interface devices such as a display screen, including touch display screens or multitouch display screens, keyboard or other input devices, microphones, speakers, etc. In other embodiments, the system 150 may be any type of computing system (e.g. desktop personal computer, laptop, workstation, net top etc.).

The external memory 158 may include any type of memory. For example, the external memory 158 may be SRAM, dynamic RAM (DRAM) such as synchronous DRAM (SDRAM), double data rate (DDR, DDR2, DDR3, etc.) SDRAM, RAMBUS DRAM, low power versions of the DDR DRAM (e.g. LPDDR, mDDR, etc.), etc. The external memory 158 may include one or more memory modules to which the memory devices are mounted, such as single inline memory modules (SIMMs), dual inline memory modules (DIMMs), etc. Alternatively, the external memory 158 may include one or more memory devices that are mounted on the IC 152 in a chip-on-chip or package-on-package implementation.

FIG. 10 is a block diagram of one embodiment of a computer accessible storage medium 160 storing an electronic description of the IC 152, illustrated at reference numeral 162. More particularly, the description may include at least the computation engine 10 and/or the processor 12. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g. synchronous dynamic RAM (SDRAM), Rambus DRAM (RDRAM), static RAM (SRAM), etc.), ROM, or Flash memory. The storage media may be physically included within the computer to which the storage media provides instructions/data. Alternatively, the storage media may be connected to the computer. For example, the storage media may be connected to the computer over a network or wireless link, such as network attached storage. The storage media may be connected through a peripheral interface such as the Universal Serial Bus (USB). Generally, the computer accessible storage medium 160 may store data in a non-transitory manner, where non-transitory in this context may refer to not transmitting the instructions/data on a signal. For example, non-transitory storage may be volatile (and may lose the stored instructions/data in response to a power down) or non-volatile.

Generally, the electronic description 162 of the IC 152 stored on the computer accessible storage medium 160 may be a database which can be read by a program and used, directly or indirectly, to fabricate the hardware comprising the IC 152. For example, the description may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the IC 152. The netlist may then be placed and routed to produce a data set describing geometric shapes to be applied to masks. The masks may then be used in various semiconductor fabrication steps to produce a semiconductor circuit or circuits corresponding to the IC 152. Alternatively, the description 162 on the computer accessible storage medium 300 may be the netlist (with or without the synthesis library) or the data set, as desired.

While the computer accessible storage medium 160 stores a description 162 of the IC 152, other embodiments may store a description 162 of any portion of the IC 152, as desired (e.g. the computation engine 10 and/or the processor 12, as mentioned above).

Numerous variations and modifications will become apparent to those skilled in the art once the above disclosure is fully appreciated. It is intended that the following claims be interpreted to embrace all such variations and modifications.

1-7. (canceled)

8. A system comprising:
a processor configured to fetch a first instruction and to issue the first instruction to a compute engine; and
the compute engine coupled to the processor, wherein:
the compute engine includes a first memory storing data, during use, that defines a plurality of intervals of values for an input value;
the compute engine is configured to identify at most one interval of the plurality of intervals that contains an input operand value of the first instruction, responsive to the first instruction;
the compute engine is configured to write an interval number corresponding to the at most one interval to a target memory location of the first instruction; and
wherein a number of the plurality of intervals is inversely dependent on a data size of the input operand value.

9. A compute engine comprising:
a first memory storing data, during use, that defines a plurality of intervals of values for an input value; and
a range circuit coupled to the first memory and, responsive to a range instruction issued to the compute engine, the range circuit is configured to identify at most one interval of the plurality of intervals that contains an input operand value of the range instruction, and the range circuit is further configured to write an interval number corresponding to the at most one interval to a target memory location of the range instruction, wherein a number of the plurality of intervals is inversely dependent on a data size of the input operand value.

10. The compute engine as recited in claim 9 wherein the input operand value is a first vector element of a plurality of vector elements in an input vector to the range instruction, and wherein the range circuit is configured, in response to the range instruction, to identify a plurality of at most one intervals, wherein respective ones of the plurality of at most one intervals correspond to respective ones of the plurality of vector elements.

11. The compute engine as recited in claim 10 wherein the input vector is stored in the first memory, during use.

12. The compute engine as recited in claim 9 wherein, in the event that none of the plurality of intervals contains the input operand value, the range circuit is configured to write a second interval number that does not correspond to any of the plurality of intervals.

13. The compute engine as recited in claim 9 wherein the data in the first memory comprises a table of boundary values, wherein adjacent ones of the boundary values in the table specify the plurality of intervals.

14. The compute engine as recited in claim 13 wherein a lower bound of a first interval is included in the first interval, and wherein an upper bound of the first interval is excluded from the first interval.

15. The compute engine as recited in claim 9 wherein the first memory stores, during use, a second table having entries corresponding to each interval, wherein the interval number is an index into the second table.

16. The compute engine as recited in claim 15 wherein each entry in the second table stores a vector of coefficients for a polynomial that approximates a transcendental function within the corresponding interval, during use, and wherein the compute engine comprises a second circuit configured to evaluate the polynomial responsive to a second instruction issued to the compute engine.

17. The compute engine as recited in claim 15 wherein the first memory stores, during use, a plurality of the second tables corresponding to a plurality of transcendental functions.

18-20. (canceled)

21. The system as recited in claim 8 wherein the input operand value is a first vector element of a plurality of vector elements in an input vector for the first instruction, and wherein the compute engine is configured, in response to the first instruction, to identify a plurality of at most one intervals, wherein respective intervals correspond to respective ones of the plurality of vector elements.

22. The system as recited in claim 8 wherein the data in the first memory comprises a table of boundary values, wherein adjacent ones of the boundary values in the table specify the plurality of intervals.

23. The system as recited in claim 22 wherein a lower bound of a first interval is included in the first interval, and wherein an upper bound of the first interval is excluded from the first interval.

24. The system as recited in claim 8 wherein the first memory stores, during use, a second table having entries corresponding to each interval, wherein the interval number is an index into the second table.

25. The system as recited in claim 24 wherein each entry in the second table stores a vector of coefficients for a respective polynomial of a plurality of polynomials that approximates a transcendental function within a corresponding interval, during use, and wherein the compute engine is configured to evaluate the respective polynomial responsive to a second instruction from the processor.

26. The system as recited in claim 24 wherein the first memory stores, during use, a plurality of instances of the second table corresponding to a plurality of transcendental functions.

27. The system as recited in claim 8 wherein, in the event that none of the plurality of intervals contains the input operand value, the compute engine is configured to write a second interval number that does not correspond to any of the plurality of intervals.

28. A method comprising:
identifying at most one interval of a plurality of intervals defined by data stored in a first memory of a compute engine that executes a first instruction, wherein the at most one interval contains an input operand value of the first instruction; and
writing, by the compute engine, an interval number corresponding to the at most one interval to a target memory location of the first instruction, wherein a number of the plurality of intervals is inversely dependent on a data size of the input operand value.

29. The method as recited in claim 28 wherein the input operand value is a first vector element of a plurality of vector elements in an input vector to the first instruction, and wherein identifying the at most one interval comprises identifying a plurality of at most one intervals, wherein respective intervals correspond to respective ones of the plurality of vector elements.

30. The method as recited in claim 28 further comprising storing a second table in the first memory, the second table having entries corresponding to each interval, wherein the interval number is an index into the second table, and wherein each entry in the second table stores a vectors of coefficients for a polynomial that approximates a transcendental function within a corresponding interval, and the method further comprises evaluating the polynomial responsive to a second instruction issued to the compute engine.
